(19) United States
(12) Patent Application Publication
(10) Pub. No.: US 2009/0029679 A1
(43) Pub. Date: Jan. 29, 2009

(54) SYSTEM AND METHOD TO PROVIDE A MOBILE PHONE CALLER WITH A LIKELY RESPONSE TIME

(76) Inventors: Teng Hu, Austin, TX (US); Dhaval K. Shah, Nadiad (IN); Ankur Bk Shah, Surat (IN); Ganesh Sivamani, Pune (IN)

Correspondence Address: IBM CORP (YA);C/O YEE & ASSOCIATES PC, P.O. BOX 802333, DALLAS, TX, 75380, US

(21) Appl. No.: 11/828,125

(22) Filed: Jul. 25, 2007

(51) Int. Cl. H04Q 7/22

(52) U.S. Cl. 455/412.1

(57) ABSTRACT

A call response time program in the memory of a server computer interacts with a mobile phone communication program to give a caller a likely response time when the call has been missed. The software comprises a configuration program, a call analyzer program, a message program, and a billing program. Auto profiling may be selected and an artificial intelligence program can be invoked. The configuration program creates a plurality of user profiles and a plurality of message files. The call analyzer program creates a plurality of user histories and may optionally invoke the artificial intelligence program. The message program responds to a missed call by sending an appropriate message indicating a likely response time. Alternatively, an interactive voice response system (IVRS) may be used.

### FIELD OF THE INVENTION

The present invention relates generally to methods for sending and receiving communications over mobile phones in general and specifically providing a caller with a likely response time by the person called.

### BACKGROUND OF THE INVENTION

Mobile phones provide rapid and convenient communications, but a person called is not always available to answer the call. Most mobile phone service providers will provide an indication on the phone of the person called that a call was missed and a display of the caller's number. In addition, the person calling may leave a message, and the person called will receive an indication that a message is waiting. In either event, the person called can then return the call when he is able to do so, but the person who made the call must wait for the call to be returned. Since the person making the call cannot be certain that the call was reported, or that the message was received, additional calls may be made. In the event that the call is important and not returned quickly, it is likely the caller will place additional calls because the caller does not know the schedule or situation of the person called and must contend with uncertainty about the receipt of the call or message. For example, the person called may be in meetings during the morning and would not be able to return the call until the afternoon, but the person calling is unaware of this schedule.

Therefore, a need exists for a way to provide a caller with information about a called party's likely response time.

### SUMMARY OF THE INVENTION

A call response time program in the memory of a server computer interacts with a mobile phone communication program to give a caller a likely response time when the call made has been missed. The software comprises a configuration program, a call analyzer program, a message program, and a billing program. Auto profiling can be elected, and an artificial intelligence program can be invoked. The configuration program creates a plurality of user profiles and a plurality of message files. The call analyzer program creates a plurality of user histories and may optionally invoke the artificial intelligence program. The message program responds to a missed call by sending an appropriate message indicating a likely response time. Alternatively, an interactive voice response system (IVRS) may be used.

### BRIEF DESCRIPTION OF THE DRAWINGS

The novel features believed characteristic of the invention are set forth in the appended claims. The invention itself, however, as well as a preferred mode of use and further objectives and advantages thereof, will best be understood by reference to the following detailed description of an illustrative embodiment when read in conjunction with the accompanying drawings, wherein:

FIG. 1 is an illustration of a mobile phone communication system;

FIG. 2 is an illustration of the configuration of the call response time application in a memory of a server computer;

FIG. 3 is an illustration of the logic of the configuration program;

FIG. 4 is an illustration of the logic of the call analyzer program;

FIG. 5 is an illustration of the logic of the artificial intelligence program; and

FIG. 6 is an illustration of the logic of the message program.

### DETAILED DESCRIPTION OF THE PREFERRED EMBODIMENT

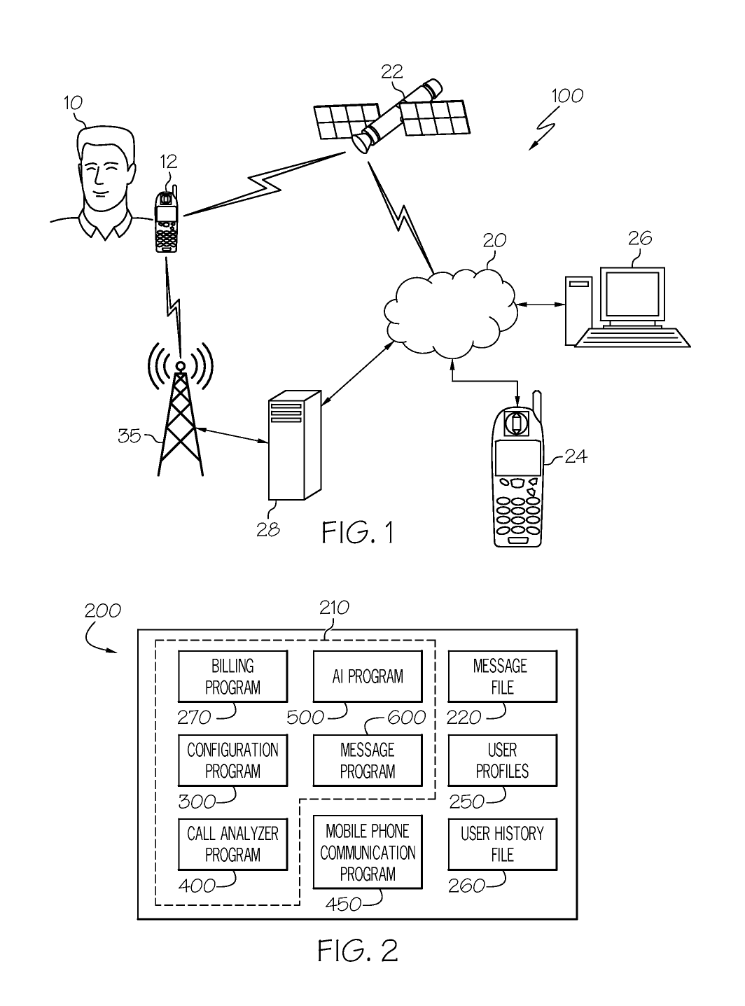

FIG. 1 is an illustration of a mobile phone system 100 in which the call response time application may be implemented. Mobile phone system 100 comprises user 10, user cellular phone 12, network 20, personal computer 26, caller cellular phone 24, server computer 28, transmitter 35, and satellite 22.

FIG. 2 depicts one configuration of call response time application 210 in server memory 200. Call response time application 210 comprises billing program 270, configuration program 300, call analyzer program 400, artificial intelligence (AI) program 500, and message program 600. Call response time application 210 interacts with mobile phone communication program 450 to monitor calls and to access an Interactive Voice Response System (IVRS) (not shown) incorporated into mobile phone communication program 450. As used herein, Interactive Voice Response System (IVRS) means a system that allows a computer to detect voice and touch tones from a normal phone call and respond with pre-recorded audio messages whereby a two way interaction with a caller is provided. Files comprise user history files 260, user profiles 250, and message files 220.

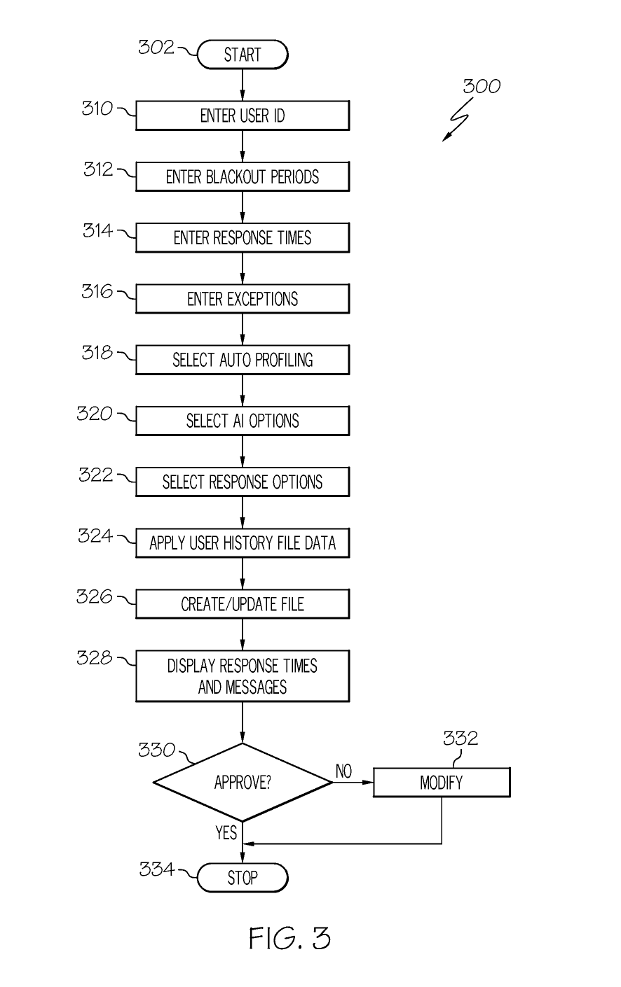

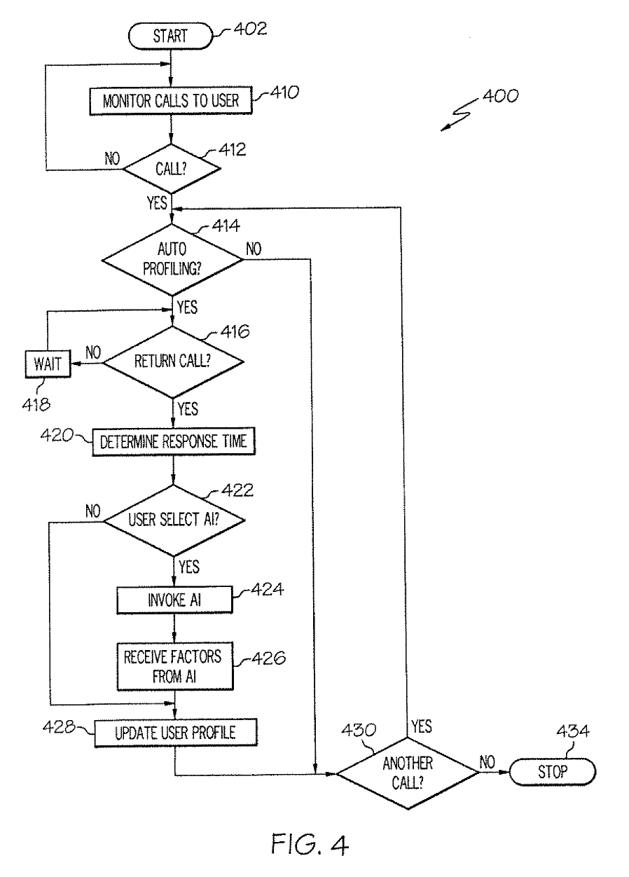

FIG. 3 depicts configuration program 300. Configuration program 300 starts (302) and prompts a user to enter a user identification (310). The user identification number may be the user's cellular telephone number, or it may be another number associated with the user's cellular telephone number. Next the user enters known blackout periods (312). Known blackout periods are times when the user knows that he is not going to return cellular phone calls. For example, the user may enter the hours when the user is sleeping, has regularly scheduled meetings, has travel plans and will be aboard an aircraft, or has scheduled personal time during which the user does not want to receive calls, such as a family dinner time or attendance at an event. Next, the user enters the time period during which calls made during a blackout period will be returned (314). The user then enters exceptions (316). The user may designate certain callers as exceptions if the user desires to receive calls from these callers during the blackout period. Configuration program 300 prompts the user to select auto profiling (318). Auto profiling allows the user's profile to be updated automatically (see FIG. 4) each time the user receives a call and responds to the call. Configuration program 300 then prompts the user to select or decline interaction with AI program 500 (320). AI program 500 can access and extract additional information about the user to refine the user profile for response times. AI program 500 can analyze extracted information, such as message content or directories, identify emergency calls, and adjust the response time based on the user's location. For example, AI program 500 could identify the user's cell phone location using GPS coordinates and adjust the response time based upon the user's time zone and the caller's time zone. AI 500 has the capability to access the user's calendaring program and to analyze user activities in relationship to response time. Persons skilled in the art are aware of many different options that can be provided by artificial intelligence. Configuration program 300 prompts the user to select response options (322). For example, response options could be text messages, pre-recorded messages, or interactive voice response messages from mobile phone communication program 450. Next configuration program 300 applies the user history file data (324) to create additional response times (326). Configuration program 300 then displays response times and messages associated with the response times for the user to review (328) and determines whether the user approves the displayed response times and messages (330). If the user does not approve, the user modifies the response times and messages (332). If the user approves, configuration program 300 stops (334).

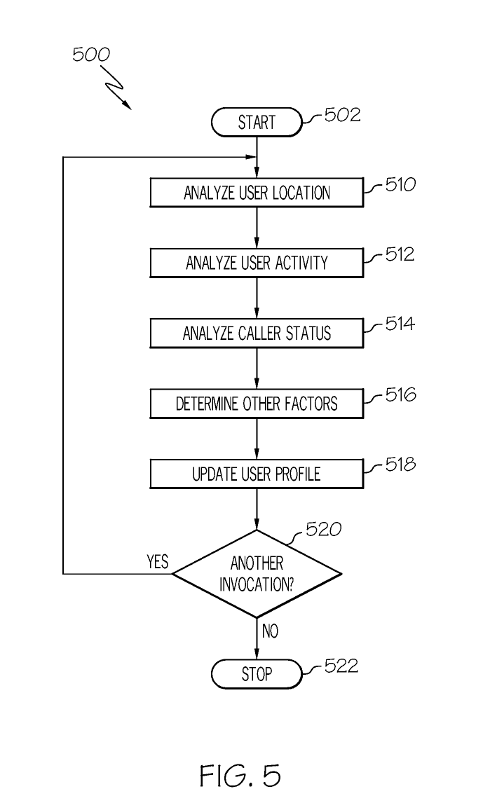

FIG. 4 depicts call analyzer program 400. Call analyzer program 400 starts (402), and monitors in the cellular phone system calls made to a user who has entered a user identification for the call response time program (410). Call analyzer program 400 determines whether a call has been received by the user (412). If a call has not been received, call analyzer program 400 continues to monitor calls to the user (410). If a call has been received, call analyzer program 400 determines whether the user has elected auto profiling (414). If not, call analyzer program goes to step 430. If so, call analyzer program determines whether the user has returned the call (416). Call analyzer program will wait until the user returns the call (418), and when the user returns the call, will determine user's response time (420). Call analyzer program 400 determines whether the user selected invocation of AI 500 (422). If the user selected to invoke AI 500, call analyzer program 400 invokes AI 500 (424) and receives factors from AI 500 upon completion of AI 500's analysis (see FIG. 5) (426). Call analyzer program 400 then updates the user history file (428). If the user did not select invocation of AI 500, call analyzer program 400 will update the user profile (428) immediately after determining the user's response time. Call analyzer program 400 then determines whether there is another call to the user to process (430), and if so, goes to step 414, and if not, stops (434).

FIG. 5 depicts the logic of artificial intelligence (AI) program 500. AI program 500 starts (502) when invoked by call analyzer program 400 (see FIG. 4). AI 500 analyzes the user's location using GPS information obtained from the user's cell phone (510). AI 500 analyzes the user's activity using information extracted from the user's calendaring program (512). AI 500 analyzes the caller's status using a phone directory, personnel database, or other files indicating the relationship of the caller to the user (514). Finally, AI 500 determines whether there are other factors which might affect the user's response time (516). For example, AI 500 may access weather alerts for the location of the user and determine if weather may be a factor in the user's response time. Persons skilled in the art are aware of other factors that AI 500 may incorporate into the user profile. AI 500 then updates the user profile (518). AI 500 may receive another invocation by call analyzer program 400 (520), and if so, goes to step 510, or if not, stops (522).

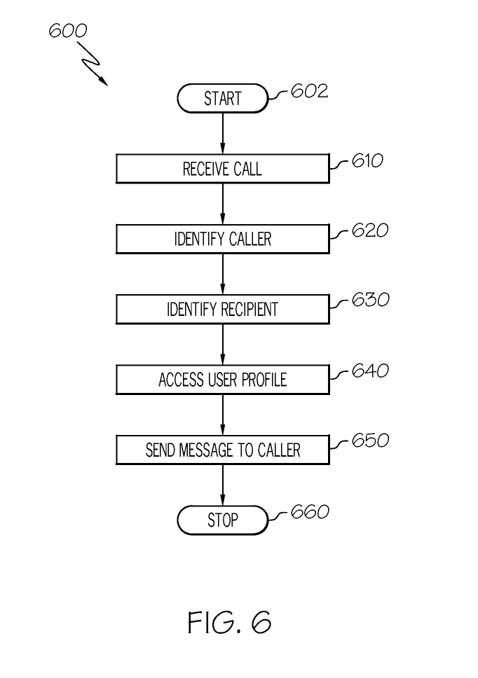

FIG. 6 depicts message program 600. Message program 600 starts (602) and determines when a user who has entered a user identification into the system receives a call (610). Message program 600 identifies the caller (620) and recipient (630). Message program 600 accesses user profile 250 (640) and sends the appropriate message to the caller (650). An appropriate message can be sent in a form selected by the user when selecting response options in configuration program 300 (see FIG. 3). For example, in the case of voice mail, the user may elect to send the likely response time in a text message, a voice message, or through an Interactive Voice Response incorporated into mobile phone communication program 450 (see FIG. 2). Likewise, the user could select any medium for indicating a likely response time, including a messaging system or an Interactive Voice Response System. Message program 600 stops until the next call is received (660).

With respect to the above description, it is to be realized that the optimum dimensional relationships for the parts of the invention, to include variations in size, materials, shape, form, function, manner of operation, assembly, and use, are deemed readily apparent and obvious to one of ordinary skill in the art. The present invention encompasses all equivalent relationships to those illustrated in the drawings and described in the specification. The novel spirit of the present invention is still embodied by reordering or deleting some of the steps contained in this disclosure. The spirit of the invention is not meant to be limited in any way except by proper construction of the following claims.

What is claimed is:

1. An apparatus comprising:
a server computer containing a storage readable medium;
a cellular telephone communication program encoded on the storage readable medium;
a call response information program encoded on the storage readable medium;
wherein, responsive to a user receiving a cellular telephone call from a sender, the call response information program causes the server computer to send a message to the sender providing a likely response time by the user.

2. The apparatus of claim 1 wherein the likely response time is extracted from a profile of the user.

3. The apparatus of claim 2 wherein the profile is automatically updated prior to an extraction of the likely response time from the profile.

4. The apparatus of claim 3 wherein the profile is further updated by an application of factors received from an artificial intelligence program invoked by the call response information program.

5. The apparatus of claim 4 wherein the artificial intelligence program analyzes a location, an activity, and a status of the user in order to update the user profile.

6. A computer implemented method comprising:
a server computer having a storage readable medium and a cellular telephone communication program encoded on the storage readable medium, installing a call response information program on the storage readable medium;
wherein, responsive to transmission of a cellular telephone call to a user, using a call response information program to cause the server computer to send a message to the sender to inform the sender of the user's likely response time.

7. The computer implemented method of claim 6 further comprising:
extracting the likely response time from a profile of the user.

8. The computer implemented method of claim 7 further comprising:
automatically updating the profile prior to an extraction of the likely response time from the profile.

9. The computer implemented method of claim 8 further comprising:
updating the profile by an application of factors received from an artificial intelligence program invoked by the call response information program.

10. The computer implemented method of claim 9 further comprising:
using an artificial intelligence program, analyzing a location, an activity, and a status of the user in order to update the user profile.

11. A computer program product comprising:
a storage readable medium containing instructions to cause a computer to;
responsive to a cellular telephone transmission to a user, transmit a message to the sender providing an indication of a likely response time by the user.

12. The computer program product of claim 6 further comprising instructions to:
extract the likely response time from a profile of the user.

13. The computer program product of claim 7 further comprising instructions to:
automatically update the profile prior to an extraction of the likely response time from the profile.

14. The computer program product of claim 8 further comprising instructions to:
update the profile by an application of factors received from an artificial intelligence program invoked by the call response information program.

15. The computer program product of claim 8 further comprising instructions to:
use an artificial intelligence program to analyze a location, an activity, and a status of the user in order to update the user profile.
